(19) United States
(12) Patent Application Publication
(10) Pub. No.: US 2012/0303897 A1
(43) Pub. Date: Nov. 29, 2012

(54) CONFIGURABLE SET ASSOCIATIVE CACHE WAY ARCHITECTURE

(76) Inventors: Sakthivel Komarasamy PULLAGOUNDAPATTI, Bangalore (IN); Maulik Harshadrai Shah, Bangalore (IN)

(21) Appl. No.: 13/118,377

(22) Filed: May 28, 2011

(51) Int. Cl. G06F 12/08

(52) U.S. Cl. 711/118; 711/171; 711/E12.017

(57) ABSTRACT

System and method for dynamically configuring a set associative cache way architecture based on an application is disclosed. In one embodiment, a memory size required for the application is determined by a cache controller. Further, a required cache way size and a required number of cache ways in a set associative cache way are computed based on the determined memory size. Furthermore, the set associative cache way architecture is configured to power off selected areas of the set associative cache way based on the computed required cache way size and the required number of cache ways for running the application.

### FIELD OF TECHNOLOGY

Embodiments of the present subject matter relate to the field of microprocessor cache architecture. More particularly, embodiments of the present subject matter relate to set associative cache way architecture.

### BACKGROUND

As processor core size keeps getting smaller as technology shrinks, more and more logics are also being added to the processor core, the processors have high leakage currents and thus causing static power dissipation. Further, high performance processors are increasing in complexity and number of transistors, and thus power consumption. Furthermore, processor caches are growing at a rate faster than that of the processor logic. The net result is that the caches are consuming a larger portion of the processor's power. Additionally, high data rate is very critical to the functioning of any application. To achieve the high data rate on on-core caches instruction and data caches are tightly coupled to the processor core. Typically, access latency to the on-core cache is significantly less than that of the off-chip memory. Generally, cache architectures used in processors are of three types: [a] direct mapped cache architecture [b] fully associative cache architecture and [c] set associative cache way architecture.

Existing general purpose processors are designed to accommodate a wide variety of different applications and therefore, the manufacturers usually set the cache architecture fixed and as a compromise given current applications, technology and cost. Therefore, typically, the set associative cache way in these general purpose processors is fixed cache architecture and the number of ways and cache size in the set associative cache way cannot be altered based on an application to increase performance and as well as lower energy consumption. For example, when executing, if an application only requires 8 KB of cache memory the entire 16KB of cache memory has to be in the power up mode in the fixed cache architecture as the number of ways and cache size cannot be changed in the set associative cache way architecture.

### SUMMARY

Dynamically configurable set associative cache way architecture is disclosed. According to one aspect of the present subject matter, a method includes determining a memory size required for an application by a cache controller, computing a required cache way size and a required number of cache ways, in a set associate cache way, based on the determined memory size, and configuring the set associative cache way architecture to power off selected areas of the set associative cache way based on the computed required cache way size and the required number of cache ways for running the application. The set associative cache way includes N-ways.

In these embodiments, cache way select signals and shut down signals are generated by the cache controller based on the determined required cache way size and the required number of cache ways. Further, the set associative cache way architecture is configured to power off the selected areas of the set associative cache way based on the generated cache way select signals and the shut down signals for running the application. In one example embodiment, the generated cache way select signals and the shut down signals are drove or provided to the set associative cache way by the cache controller to configure the set associative cache way.

The method further includes invalidating the selected areas of the configured set associative cache way, and initiating a read/write operation on the configured set associative cache way.

According to another aspect of the present subject matter, a non-transitory computer-readable storage medium for dynamically configuring a set associative cache way architecture, having instructions that, when executed by a computing device causes the computing device to perform the method described above.

According to yet another aspect of the present subject matter, a dynamically configurable set associative cache way architecture includes a processor including a set associative cache way, memory coupled to the processor, an operating system residing in the memory, and a cache controller coupled to the processor. The cache controller along with the operating system performs the method described above.

The methods, and systems disclosed herein may be implemented in any means for achieving various aspects, and other features will be apparent from the accompanying drawings and from the detailed description that follow.

### BRIEF DESCRIPTION OF THE DRAWINGS

Various embodiments are described herein with reference to the drawings, wherein:

FIG. 1 illustrates a flow chart for dynamically configuring a set associative cache way architecture based on an application, according to one embodiment.

FIG. 2 illustrates a 4-way set associative cache architecture, in the context of the present subject matter;

FIG. 3 illustrates a dynamically configurable 4-way set associative cache architecture, according to one embodiment;

FIG. 4 illustrates yet another dynamically configurable 4-way set associative cache architecture, according to one embodiment;

FIG. 5 illustrates yet another dynamically configurable 4-way set associative cache architecture, according to one embodiment;

The drawings described herein are for illustration purposes only and are not intended to limit the scope of the present disclosure in any way.

### DETAILED DESCRIPTION

Dynamically configurable set associative cache way architecture is disclosed. In the following detailed description of the embodiments of the present subject matter, reference is made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

The present subject matter enables to dynamically configure required number of cache ways and required cache way sizes in a set associative cache way based on an application and to switch-off the unused cache memory regions of the set associative cache way.

The terms ‘set associative cache way architecture’ and ‘N-way set associative cache architecture’ are used interchangeably throughout the document. “N” typically refers to 2, 4, 8 and so on. Similarly, the terms ‘set associative cache’ and ‘set associative cache way’ are used interchangeably throughout the document. Further, the terms ‘set associative cache architecture’ and ‘set associative cache way architecture’ are used interchangeably throughout the document. Also, the terms “cache way select signal” and “way_sel bit” and the terms “shut down signal” and “shut down bit” are used interchangeably throughout the document.

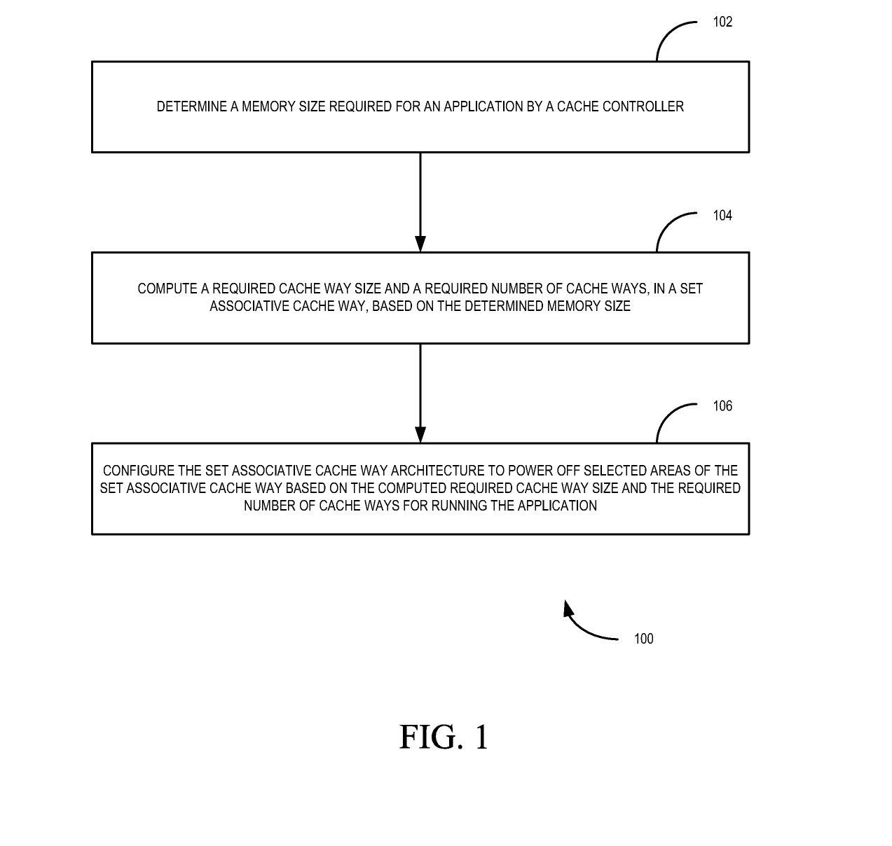

FIG. 1 illustrates a flow chart 100 for dynamically configuring a set associative cache way architecture based on an application, according to one embodiment. At block 102, a memory size required for the application is determined by a cache controller. At block 104, a required cache way size and a required number of cache ways in a set associative cache way are computed based on the determined memory size. The set associative cache way includes N-ways, where N=2, 4, 8 and so on.

At block 106, the set associative cache way architecture is configured to power off selected areas of the set associative cache way based on the computed required cache way size and the required number of cache ways for running the application. In these embodiments, the selected areas of the set associative cache way are powered off to reduce logical size of the set associative cache way in order to save power.

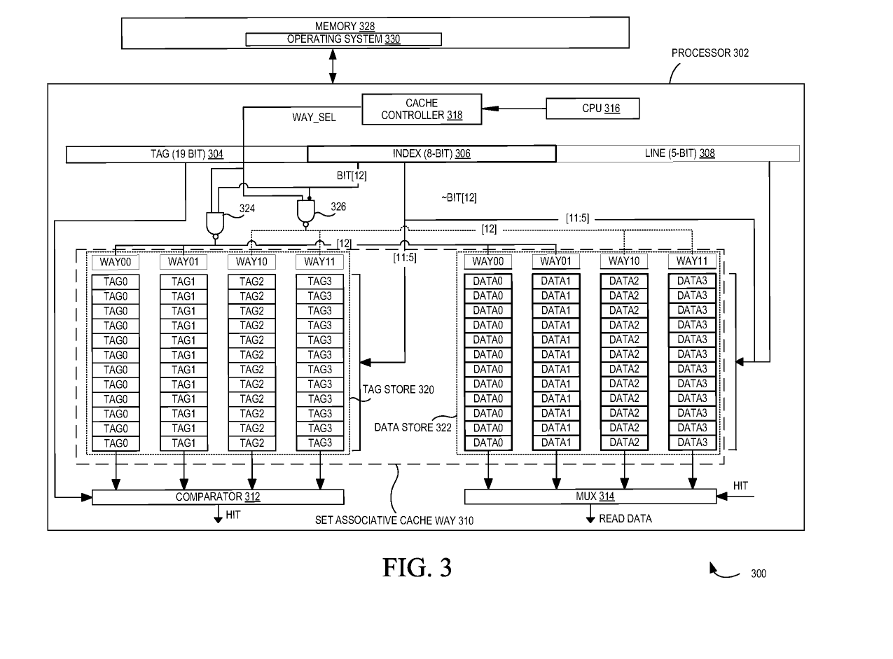

In these embodiments, cache way select signals and shut down signals are generated by the cache controller based on the determined required cache way size and the required number of cache ways. Further, the set associative cache way architecture is configured to power off the selected areas of the set associative cache way based on the generated cache way select signals and the shut down signals for running the application. In one example embodiment, the generated cache way select signals and the shut down signals are drove or provided to the set associative cache way by the cache controller to configure the set associative cache way. Driving the generated cache way select signals and the shut down signals to the set associative cache way are explained in greater detail with respect to FIGS. 3-5.

Further, driving the generated cache way select signals and the shut down signals to the set associative cache way enables the set associative cache way to power off the selected areas of the set associative cache way based on the configured set associative cache way. In other words, the selected areas of the configured set associative cache way are invalidated. For example, the cache ways of the set associative cache way receiving the cache way select signals may remain in power on mode and the cache ways of the set associative cache way receiving the shut down signals may remain in power off mode as explained in FIGS. 3-5.

Furthermore, a read/write operation is initiated on the configured set associative cache way. In these embodiments, the read/write operation is initiated on the power on areas of the configured set associative cache way.

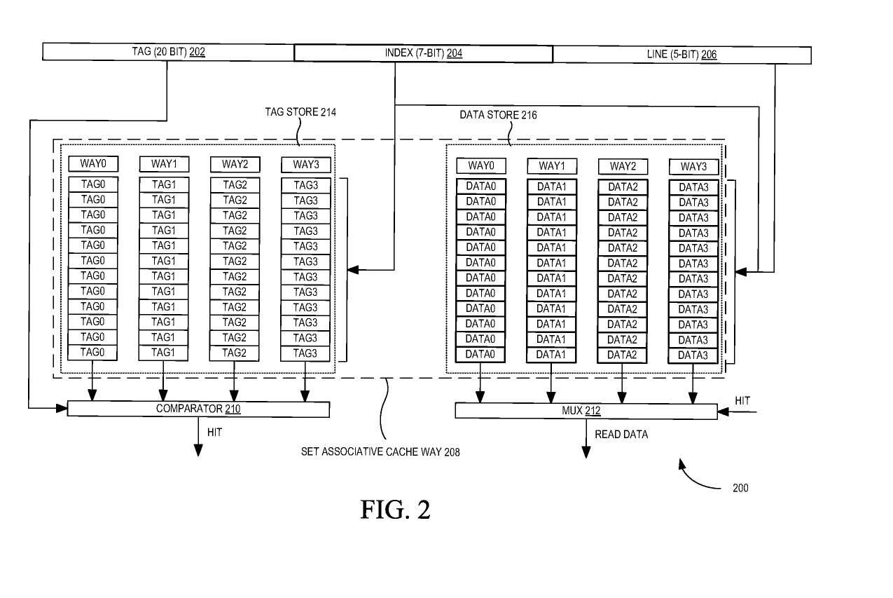

FIG. 2 illustrates a 4-way set associative cache architecture 200, in the context of the present subject matter. Particularly, the 4-way set associative cache architecture 200 includes a set associative cache way 208 for storing a plurality of tags and data corresponding to the tags, a comparator 210, and a multiplexer 212. As shown in FIG. 2, the set associative cache way 208 includes a tag store 214 and a data store 216. Further, each of the tag store 214 and a data store 216 includes 4 cache ways, i.e., way00, way01, way10, and way11. In this example, each cache way is 4 KB, i.e. 128 line entries. For example, the data store 216 includes a data random access memory (RAM) and the tag store 214 includes a tag RAM.

Further, the 4-way set associative cache architecture 200 includes a cache address used to concurrently address the tag store 214 and the data store 216. The format of the cache address includes a tag field 202, an index field 204 and a line field 206. For example, for 16 KB cache memory, to represent 128 line entries, the cache index field 204 includes 7 bits, the tag field 202 includes 20 bits and the line field 206 includes the remaining 5 bits of the main memory address. For example, the cache address includes a read address. Further, the data width is 32 bit, address width is 32 bit and the line size is 8 words [8×4 bytes], i.e. 5 bits are used to represent word and byte locations.

When requesting data from the set associative cache way 208, a central processing unit (CPU) offers the cache address for reading on a line. For example, data stored in the data store 216 are associated with 32 bytes of word. Each data line in the data store 216 is addressable by the bits in the index field 204. The tag store 214 stores an address tag for each data line of the data store 216.

The index field 204 in the cache address is used in accessing an address tag on a current data line in the data store 216 at a specific position of the tag data store 214. The tag store 214 loads an address tag on a line. The comparator 210 compares an address tag of the tag store 214 with an address tag of the read address. If the two address tags are identical, the comparator 210 generates a HIT signal to the line.

At the same time with the access to an address tag of the tag store 214, the cache index field 204 and the line field 206 of the cache address are used to access to a data word in the data store 216. The data word of the data store 216 is loaded on an output line. The HIT signal on the line makes the multiplexer 212 to read the data from the output line. And then, the data is transferred to the CPU. If the address tag of the tag store 214 is not in accord with the address tag of the read address, an invalid signal or miss signal is generated from the comparator 210, informing the tag store 214 of a miss state.

The 4-way set associative cache way architecture 200 shown in FIG. 2 is a fixed structure and may not be possible to alter the number of cache ways based on the application code. For example, for executing a small application which requires only 8 KB cache memory, the entire 16 KB cache memory needs to be kept in the power up or power on mode, thereby consuming a significant amount of the static power.

In one embodiment, the present subject matter enables changing the set associative cache ways to dynamically configure the number of ways and cache sizes based on the applications as shown in FIGS. 3-5.

FIG. 3 illustrates a dynamically configurable 4-way set associative cache architecture 300, according to one embodiment. Particularly, the dynamically configurable 4-way set associative cache architecture 300 includes a processor 302 and memory 328 including an operating system 330. Further, the processor 302 includes a set associative cache way 310 for storing a plurality of tags and data corresponding to the tags, a comparator 312, and a multiplexer 314. As shown in FIG. 3, the set associative cache way 310 includes a tag store 320 and a data store 322. Further, each of the tag store 320 and the data store 322 includes 4 cache ways, i.e., way00, way01, way10, and way11. For example, the data store 322 may include a data RAM and the tag store 320 may include a tag RAM.

Further, the processor 302 includes a cache address used to concurrently address the tag store 320 and the data store 322. The format of the cache address includes a tag field 304, an index field 306 and a line field 308. Furthermore, the processor 302 includes a CPU 316 and a cache controller 318 coupled to the CPU 316.

In one example embodiment, the 4-way set associative cache 310 can be configured as 2-way set associative cache, for example configuring from 4 cache ways to 2 cache ways, using a software bit “way select” based on the applications. The “way select” bit (also referred to as “way select” signal) is generated by the CPU 316 using the cache controller 318. In these embodiments, the cache controller 318 along with the operating system 330 computes a required cache way size and a required number of cache ways based on the memory size required for the application. The “way select” bit includes either 1 or 0.

Further, each cache way is 4 KB for the 4-way set associative cache whereas each cache way is 8 KB for the 2-way set associative cache. Furthermore, index or index field in the 4-way set associative cache is 7 bits and index for the 2-way set associative cache is 8 bits (e.g., as shown in the index field 306). In one embodiment, the extra index bit (i.e., bit [12]) in the 2-way set associative cache is used to select between way0 [way00, way01] and way1 [way10, way11]. Further, tag address in the 2-way set associative cache is 19 bits instead of 20 bits (for the 4-way set associative cache), i.e., last bit should be excluded from the comparison.

In the example embodiment illustrated in FIG. 3, the “way select” bit from the cache controller 318 and the bit [12] from the index field 306 of the cache address are inputted to the 4 ways, i.e., way00, way01, way10, and way11 via NAND gates 324 and 326. For example, the “way select” bit and the bit [12] are inputted to the way00 and way01 via the NAND gate 324 and the “way select” bit and the negation of bit [12] are inputted to the way10 and way11 via the NAND gate 326.

The following points depict an example for dynamically configuring the 4-way set associative cache to 2-way set associative cache.
1. By default, the set associative cache way 310 is configured for 4-way set associative cache.
2. The CPU 316 can configure “way_sel” bit using the cache controller 318 based on the required cache way size and the required number of cache ways for the application.
3. When the “way_sel” bit is 0, the set associative cache way 310 is same as the default configuration (i.e. the 4-way set associative cache).

4. Before changing the set associative cache way 310 configuration, disable the cache ways and set the “way_sel” bit and re-enable the cache ways.
5. Depending on the application, the CPU 316 can configure the “way_sel” bit to “1” by executing the firmware application code.
6. The “way_sel” bit is logically NANDed with bit [12] (i.e., as shown in the NAND gate 324) and with negation of the bit [12] (i.e., as shown in the NAND gate 326) to configure the cache ways (way00, way01, way10 and way11).
7. When the “way_sel” bit=1 and the “bit [12]”=0, the way00 and the way01 are active.
8. When the “way_sel” bit=1 and the “bit [12]”=1, the way10 and the way11 are active.

The following table 1 depicts the 4-way and 2-way set associative caches based on the software controllable “way_sel” bit or “way_sel” signal.

TABLE 1

| way_sel | Bit [12] | Index | Tag | Active Ways | Comments |
|---|---|---|---|---|---|
| 1 | 0 | 8 | 19 | way00, way01 | Lines 0-127 is |
| | | | | | active |
| 1 | 1 | 8 | 19 | way10, way11 | Lines 128-255 is |
| | | | | | active |
| 0 | Merged | 7 | 20 | All ways are | Should be |
| | with Tag | | | active | reconfigurable, |
| | bit | | | | it's same as |
| | | | | | FIG. 1 |

In operation, when the “way_sel” bit is 1 and the bit [12] is 0, then the output of the NAND gate 324 is 1 and the output of the NAND gate 326 is 0. In this case, the output of the NAND gate 324 drives the way00 and way01 to active mode and the output of the NAND gate 326 drives the way10 and way11 to inactive mode thereby configuring the 4-way set associative cache to the 2-way set associative cache.

Similarly, when the “way_sel” bit is 1 and the bit [12] is 1, then the output of the NAND gate 324 is 0 and the output of the NAND gate 326 is 1. In this case, the output of the NAND gate 324 drives the way00 and way01 to inactive mode and the output of the NAND gate 326 drives the way10 and way11 to active mode thereby configuring the 4-way set associative cache to the 2-way set associative cache.

Further, the 4 cache ways of the set associative cache way 310 can remain in active mode when the extra bit (i.e., the bit [12]) in the index field 306 is merged with the bits in the tag field 304. Similarly, the same 4-way set associative cache structure can also be scaled down to direct mapped cache or 1-way set associative cache.

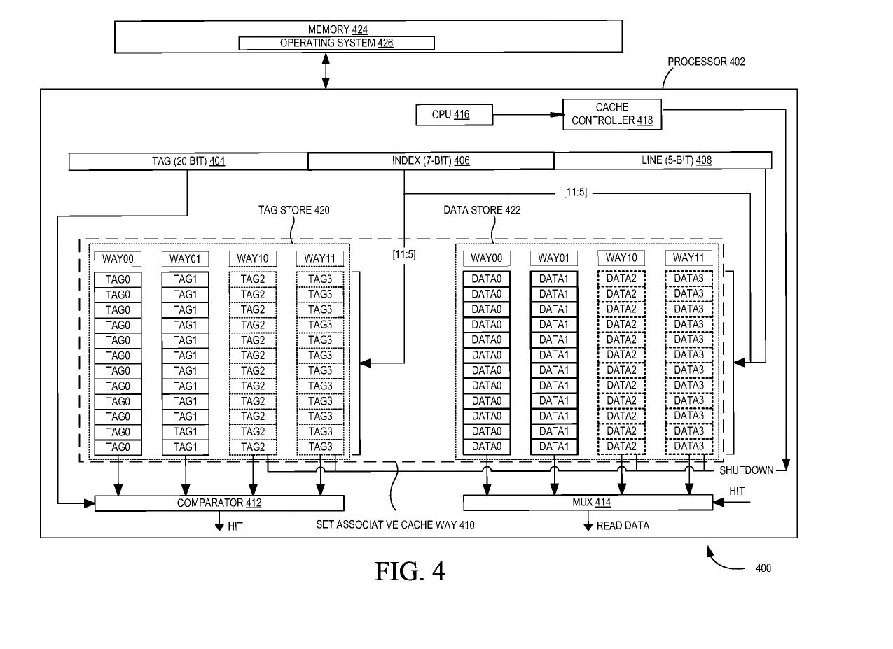

FIG. 4 illustrates yet another dynamically configurable 4-way set associative cache architecture 400, according to one embodiment. Particularly, the dynamically configurable 4-way set associative cache architecture 400 includes a processor 402 and memory 424 including an operating system 426. Further, the processor 402 includes a set associative cache way 410 for storing a plurality of tags and data corresponding to the tags, a comparator 412, and a multiplexer 414. As shown in FIG. 4, the set associative cache way 410 includes a tag store 420 and a data store 422. Further, each of the tag store 420 and the data store 422 includes 4 cache ways, i.e., way00, way01, way10, and way11.

Further, the processor 402 includes a cache address used to concurrently address the tag store 420 and the data store 422. The format of the cache address includes a tag field 404, an index field 406 and a line field 408. Furthermore, the processor 402 includes a CPU 416 and a cache controller 418 coupled to the CPU 416.

In one example embodiment, the 4-way set associative cache 410 can be configured as 8 KB 2-way set associative cache, where 8 KB of the 2-way set associative cache is used and rest of the cache ways are powered down using a “shut down” bit based on the applications. The “shut down” bit is generated by the CPU 416 using the cache controller 418. In these embodiments, the cache controller 418 along with the operating system 426 computes a required cache way size and a required number of cache ways based on the memory size required for the application.

In other words, the cache ways in the 4-way set associative cache 410 are dynamically enabled/disabled to save power based on the application. In the example embodiment illustrated in FIG. 4, the way00 and the way01 are active and the way10 and the way11 are kept in the power down mode based on the external “shut down” bit from the cache controller 418. Similarly, the way10 and the way11 can also be activated and the way00 and the way01 can be kept in the power down mode based on the external “shut down” bit from the cache controller 418. The cache controller 418 requires very minimal changes in the cache logic. The same approach can also be used for configuring 1-way set associative cache or direct mapped set associative cache.

The following points depict an example for dynamically configuring the 4-way set associative cache to 8 KB 2-way set associative cache.
1. By default, the set associative cache way 410 is configured for 4-way set associative cache.
2. The CPU 416 can configure “shut down” bit using the cache controller 418.
3. When the “shut down” bit is “0”, the set associative cache way 410 is same as the default configuration (i.e., the 4-way set associative cache).
4. Before changing the set associative cache way 410 configuration, disable the cache ways and set the “shut down” bit and re-enable the cache ways.
5. Depending on the application, the CPU 416 can configure the “shut down” bit to “1” by executing the firmware application code.
6. When the “shut down” bit is set, the 4-way set associative cache is configured as 2 way set associative cache. Control logic inside the cache controller 418 is modified based on the “shut down” bit to select the way00 and the way01.
7. When the “shut down” bit=0, all cache ways, i.e., the way00, way01, way10 and way11 are active.
8. When the “shut down” bit=1, then the way00 and way01 are active and the way10 and way11 will be powered down to save leakage power.

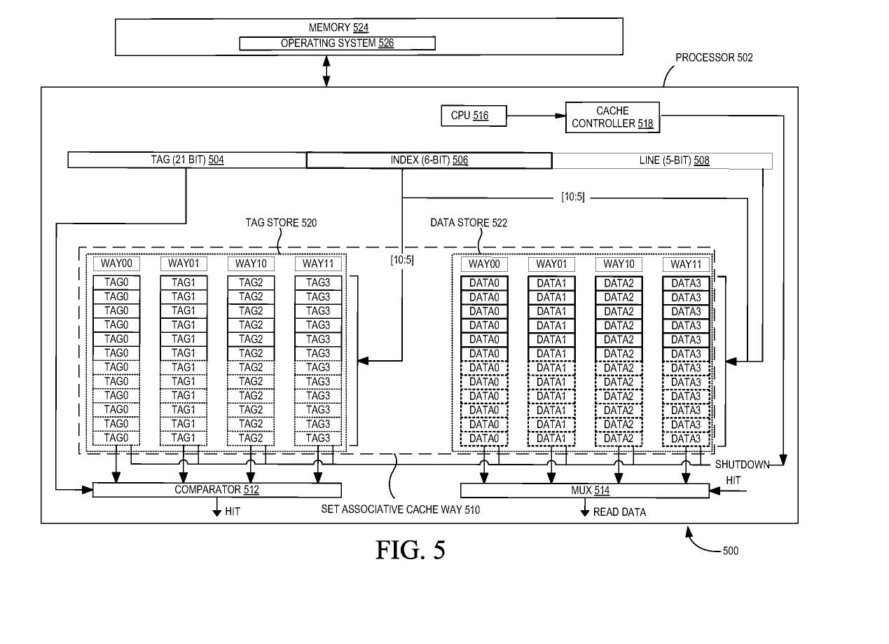

FIG. 5 illustrates yet another dynamically configurable 4-way set associative cache architecture 500, according to one embodiment. Particularly, the dynamically configurable 4-way set associative cache architecture 500 includes a processor 502 and memory 524 including an operating system 526. Further, the processor 502 includes a set associative cache way 510 for storing a plurality of tags and data corresponding to the tags, a comparator 512, and a multiplexer 514. As shown in FIG. 5, the set associative cache way 510 includes a tag store 520 and a data store 522. Further, each of the tag store 520 and the data store 522 includes 4 cache ways, i.e., way00, way01, way10, and way11.

Further, the processor 502 includes a cache address used to concurrently address the tag store 520 and the data store 522. The format of the cache address includes a tag field 504, an index field 506 and a line field 508. Furthermore, the processor 502 includes a CPU 516 and a cache controller 518 coupled to the CPU 516.

In one example embodiment, the 4-way set associative cache 510 can be configured as 8 KB 4-way set associative cache based on the applications and rest/remaining 8 KB of the 4-way set associative cache can be kept in power down mode using a “shut down” bit to save power (e.g., as shown in FIG. 5). The “shut down” bit is generated by the CPU 516 using the cache controller 518.

In other words, cache memory size can be dynamically configured based on the application and rest of the cache memory can be powered down to save the power. In the example embodiment illustrated in FIG. 5, only 8 KB cache of the set associative cache way 510 is used and remaining 8 KB is powered down using the “shut down” bit. In this case, the bits in the index field 506 are changed to 6 bits from 7 bits and the bits in the tag field 504 are changed to 21 bits from 20 bits.

The following points depict an example for dynamically configuring the 4-way set associative cache to 8 KB 4-way set associative cache.
1. By default, the set associative cache way 510 is configured for 4-way set associative cache.
2. Then the CPU 516 can configure “shut down” bit using the cache controller 518.
3. When the “shut down” bit is “0”, the set associative cache way 510 is same as default configuration (i.e., the 4-way set associative cache).
4. Before changing the set associative cache way 510 configuration, disable the cache ways and set the “shut down” bit and re-enable the cache ways.
5. Depending on the application, the CPU 516 can configure the “shut down” bit to “1” by executing the firmware application code.
6. When the “shut down” bit is set, 16 KB 4-way set associative cache is configured as 8 KB 4-way set associative cache. Control logic inside the cache controller 518 is modified based on the “shut down” bit to select the upper half cache entries of the way00, way01, way10 and way11.
7. When the “shut down” bit=0, then all cache entries in the way00, way01, way10 and way11 are active.
8. When the “shut down” bit=1, then only upper half entries in the way00, way01, way10 and way11 are active and lower half entries in the way00, way01, way10 and way11 will be powered down to save leakage power.

With respect to the above FIGS. 3-5, the processing unit or processor (i.e., the processor 302, 402, or 502) may include the hardware architecture necessary to retrieve executable code from the memory (e.g., the memory 328, 424, or 524 respectively) and execute the executable code. The executable code may, when executed by the processor, cause the processor to implement at least the functionality of dynamically configuring a set associative cache way architecture according to the methods of the present specification described above. In the course of executing code, the processor may receive input from and provide output to one or more of the remaining hardware units.

The memory (e.g., the memory 328, 424, or 524) may be configured to digitally store data consumed and produced by the processor. The memory may also include various types of memory modules, including volatile and nonvolatile memory. For example, the memory of the present example includes Random Access Memory (RAM), Read Only Memory (ROM), and Hard Disk Drive (HDD) memory. Many other types of memory are available in the art, and the present specification contemplates the use of any type(s) of memory as may suit a particular application of the principles described herein. In certain examples, different types of memory may be used for different data storage needs. For example, in certain embodiments the processor may boot from ROM, maintain nonvolatile storage in the HDD memory, and execute program code stored in RAM.

In the example embodiment illustrated in FIGS. 3-5, the cache controller (e.g., the cache controller 318, 418 or 518 of FIGS. 3-5, respectively) along with the operating system (e.g., the operating system 330, 426 or 526) determines a memory size required for the application. Further, the cache controller computes a required cache way size and a required number of cache ways, in the set associate cache way, based on the determined memory size. Furthermore, the cache controller configures the set associative cache way architecture to power off selected areas of the set associative cache way based on the computed required cache way size and the required number of cache ways for running the application. In these embodiments, the cache controller generates cache way select signals (i.e., the way select bits) and shut down signals (i.e., the shut down bits) based on the determined required cache way size and the required number of cache ways to power off the selected areas of the set associative cache way.

The cache controller may include an internal memory having instructions capable of dynamically configuring the set associative cache way architecture.

An article comprising a non transitory computer readable storage medium having instructions thereon which when executed by a computer, cause the computer to perform the above described method. The method described in the foregoing may be in a form of a machine-readable medium embodying a set of instructions that, when executed by a machine, cause the machine to perform any method disclosed herein. It will be appreciated that the various embodiments discussed herein may not be the same embodiment, and may be grouped into various other embodiments not explicitly disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

In various embodiments, the methods and systems described in FIGS. 1 through 5 may allocate cache ways and cache way sizes based on the application and keep the unused memory banks (i.e., cache ways or entries/sizes in the cache ways) in power down mode to save power. Further, the methods and systems described in FIGS. 1 through 5 may be applicable to instruction cache and can also be extended for data cache. In addition, the same methodology may be applicable for other cache sizes.

Further, the use of methods and systems described in FIGS. 1 through 5 can be detected by dynamic allocation of cache ways and cache way sizes based on the application requirements, software intervention to allocate cache ways and sizes, power reduction based on cache configuration, and extra logic in the cache way selection path.

Although the present embodiments have been described with reference to specific example embodiments, it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method for dynamically configuring a set associative cache way architecture based on an application, comprising:
determining a memory size required for the application by a cache controller;
computing a required cache way size and a required number of cache ways, in a set associative cache way, based on the determined memory size; and
configuring the set associative cache way architecture to power off selected areas of the set associative cache way based on the computed required cache way size and the required number of cache ways for running the application.

2. The method of claim 1, wherein configuring the set associative cache way architecture to power off selected areas of the set associative cache way based on the computed required cache way size and the required number of cache ways for running the application, comprises:
generating cache way select signals and shut down signals by the cache controller based on the determined required cache way size and the required number of cache ways; and
configuring the set associative cache way architecture to power off the selected areas of the set associative cache way based on the generated cache way select signals and the shut down signals for running the application.

3. The method of claim 2, wherein configuring the set associative cache way architecture to power off the selected areas of the set associative cache way based on the generated way select signals and the shut down signals for running the application comprises:
driving the generated cache way select signals and the shut down signals to the set associative cache way by the cache controller to configure the set associative cache way; and
invalidating the selected areas of the configured set associative cache way.

4. The method of claim 3, wherein driving the generated cache way select signals and the shut down signals to the set associative cache way comprises:
enabling the set associative cache way to power off the selected areas of the set associative cache way based on the configured set associative cache way.

5. The method of claim 3, further comprising:
initiating a read/write operation on the configured set associative cache way.

6. The method of claim 1, wherein the set associative cache way includes N-ways.

7. A non-transitory computer-readable storage medium for dynamically configuring a set associative cache way architecture having instructions that, when executed by a computing device, cause the computing device to:
determine a memory size required for an application by a cache controller;
compute a required cache way size and a required number of cache ways, in a set associate cache way, based on the determined memory size; and
configure the set associative cache way architecture to power off selected areas of the set associative cache way based on the computed required cache way size and the required number of cache ways for running the application.

8. The non-transitory computer-readable storage medium of claim 7, wherein configuring the set associative cache way architecture to power off selected areas of the set associative cache way based on the computed required cache way size and the required number of cache ways for running the application, comprises:
generating cache way select signals and shut down signals by the cache controller based on the determined required cache way size and the required number of cache ways; and
configuring the set associative cache way architecture to power off the selected areas of the set associative cache way based on the generated cache way select signals and the shut down signals for running the application.

9. The non-transitory computer-readable storage medium of claim 8, wherein configuring the set associative cache way architecture to power off the selected areas of the set associative cache way based on the generated way select signals and the shut down signals for running the application comprises:
driving the generated cache way select signals and the shut down signals to the set associative cache way by the cache controller to configure the set associative cache way; and
invalidating the selected areas of the configured set associative cache way.

10. The non-transitory computer-readable storage medium of claim 9, wherein driving the generated cache way select signals and the shut down signals to the set associative cache way comprises:
enabling the set associative cache way to power off the selected areas of the set associative cache way based on the configured set associative cache way.

11. The non-transitory computer-readable storage medium of claim 9, further comprising instructions to:
initiate a read/write operation on the configured set associative cache way.

12. The non-transitory computer-readable storage medium of claim 7, wherein the set associative cache way includes N-ways.

13. A dynamically configurable set associative cache way architecture, comprising:
memory including an operating system; and
a processor coupled to the memory, wherein the processor includes:
a CPU;
a set associative cache way; and
a cache controller coupled to the CPU and the set associative cache way, wherein the cache controller along with the operating system determines a memory size required for the application, wherein the cache controller computes a required cache way size and a required number of cache ways, in the set associate cache way, based on the determined memory size, and wherein the cache controller configures the set associative cache way architecture to power off selected areas of the set associative cache way based on the computed required cache way size and the required number of cache ways for running the application.

14. The dynamically configurable set associative cache way architecture of claim 13, wherein the cache controller generates cache way select signals and shut down signals based on the determined required cache way size and the required number of cache ways, and configures the set associative cache way architecture to power off the selected areas of the set associative cache way based on the generated cache way select signals and the shut down signals for running the application.

15. The dynamically configurable set associative cache way architecture of claim 14, wherein the cache controller drives the generated cache way select signals and the shut down signals to the set associative cache way to configure the set associative cache way and invalidates the selected areas of the configured set associative cache way.

16. The dynamically configurable set associative cache way architecture of claim 15, wherein the cache controller enables the set associative cache way to power off the selected areas of the set associative cache way based on the configured set associative cache way.

17. The dynamically configurable set associative cache way architecture of claim 15, wherein the cache controller initiates a read/write operation on the configured set associative cache way.

18. The dynamically configurable set associative cache way architecture of claim 13, wherein the set associative cache way includes N-ways.
